(19) United States
(12) Patent Application Publication
(10) Pub. No.: US 2009/0163080 A1
(43) Pub. Date: Jun. 25, 2009

(54) Power plug adapter structure

(76) Inventor: Yun-Wen Peng, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,485

(22) Filed: Jul. 7, 2008

(30) Foreign Application Priority Data
Dec. 19, 2007 (TW) 096221570

(51) Int. Cl. H01R 33/94

(52) U.S. Cl. 439/628

(57) ABSTRACT

A power plug adapter structure including: a power plug having a mating face and a set of first conductive members disposed on the mating face, two lateral recesses being respectively formed on two lateral faces of the power plug, a locating dent being formed on a wall of at least one lateral recess; and a plug adapter having second conductive members and insertion slots extending to the second conductive member corresponding to the first conductive members. The plug adapter further has two lateral extension sections disposed on two sides of the plug adapter in parallel to the insertion slots corresponding to the lateral recesses. A locating rib is formed on at least one lateral extension section corresponding to the locating dent. When plug adapter is combined with the power plug, the lateral extension sections extend into the lateral recesses with the locating rib inlaid and chucked in the locating dent.

### BACKGROUND OF THE INVENTION

The present invention is related to a power plug adapter, which can be easily and firmly combined with a power plug to transform the specification of the power plug.

Taiwanese Patent Publication No. 444962 discloses a power plug adapter structure. FIG. 1 of the above Patent shows a conventional plug adapter having a set of cylindrical pins and a set of pinholes extending to the cylindrical pins. Flat pins of a plug can be inserted into the pinholes to electrically contact with the cylindrical pins. Accordingly, the flat pins of the plug can be transformed into the cylindrical pins. However, the plug is combined with the plug adapter simply by means of tight fit between the flat pins of the plug and the walls of the pinholes of the plug adapter. Therefore, after a period of use, it often takes place that the plug loosens or even detached from the plug adapter due to wear.

FIG. 2 of the above Patent shows another conventional plug adapter structured on the basis of the plug adapter of said FIG. 1. The difference therebetween is that a thread hole is formed on the plug between the flat pins and the plug adapter is formed with a through hole corresponding to the thread hole. A bolt can be passed through the through hole and screwed into the thread hole to firmly connect the plug adapter with the plug. However, it is troublesome to screw in or out the bolt when connecting the plug adapter with the plug or disconnecting the plug adapter from the plug.

To solve the above problem, the power plug adapter structure of Taiwanese Patent Publication No. 444962 includes a plug body and a pivot body pivotally connected with the plug body. The plug body has a pair of first conductive pins. The pivot body has a pair of second conductive pins and two slots corresponding to the first conductive pins. The pivot body can be pivoted toward the first conductive pins, whereby the first conductive pins can pass through the slots to electrically contact with the second conductive pins of the pivot body. Reversely, the pivot body can be pivoted away from the first conductive pins, whereby the first conductive pins are disconnected from the second conductive pins. When the first conductive pins electrically contact with the second conductive pins of the pivot body, the first conductive pins are simply clamped by the second conductive pins in the slots. Accordingly, the first conductive pins are still likely to loosen from the second conductive pins due to wear. Moreover, the pivot body is inseparably connected with the plug body. Therefore, it needs larger room to store the structure. In addition, the structure has heavier weight as a whole so that it is inconvenient to carry the structure.

Taiwanese Patent Publication Nos. 572474, 385110, I250694 and M293586 respectively disclose some power plug adapters. In each of the above Patents, the power plug has no conductive pin for electrically connecting with external power supply. The power plug is provided with additional connecting structure for connecting with an adapter unit. The assembling process is complicated. Moreover, in case of different usage, it is necessary for a user to carry at least two types of adapter units. This causes great inconvenience to the user in use of the power plug adapter.

Furthermore, some power plug adapters have exposed conductive contacts. In case that the power plug is detached from the plug adapter with the plug adapter still connected with the power supply, an accident may happen.

### SUMMARY OF THE INVENTION

It is therefore a primary object of the present invention to provide an improved power plug adapter structure, which can be firmly combined with a power plug to transform the specification of the power plug. The power plug adapter is not liable to detach from the power plug due to unexpected external force so that the safety in use can be ensured.

It is a further object of the present invention to provide the above power plug adapter structure, which can be easily combined with the power plug to facilitate use of the power plug adapter.

It is still a further object of the present invention to provide the above power plug adapter structure, which can be flushly combined with the power plug without protruding from the surface thereof.

It is still a further object of the present invention to provide the above power plug adapter structure, which has no exposed conductive contact so as to avoid accident of shock and ensure safety.

According to the above objects, the power plug adapter structure of the present invention includes: a power plug having a mating face and a set of first conductive members disposed on the mating face for electrically connecting with external power supply, two lateral recesses being respectively formed on two sides -of the power plug, a locating dent being formed on a wall of each lateral recess; and a plug adapter having a set of second conductive members and a set of insertion slots extending from one face of the plug adapter to the second conductive members. The insertion slots are aligned with and compatible with the first conductive members. The plug adapter further has two lateral extension sections disposed on two sides of the plug adapter in parallel to the insertion slots. A locating rib is formed on each lateral extension section. When the first conductive members are inserted into the insertion slots, the lateral extension sections extend into the lateral recesses with the locating ribs inlaid in the locating dents.

The lateral recess has an open side on the mating face of the power plug, whereby the lateral extension section of the plug adapter can easily extend into the lateral recess.

The present invention can be best understood through the following description and accompanying drawings wherein:

### BRIEF DESCRIPTION OF THE DRAWINGS

FIG. 1 is a perspective exploded view of a first embodiment of the power plug adapter structure of the present invention;

FIG. 2 is a perspective assembled view of the first embodiment of the power plug adapter structure of the present invention;

FIG. 3 is a partially sectional assembled view of the first embodiment of the power plug adapter structure of the present invention;

FIG. 4 is a partially sectional view according to FIG. 3, in which the plug adapter is to be separated from the power plug;

FIG. 5 is a perspective exploded view of a second embodiment of the power plug adapter structure of the present invention;

FIG. 6 is a perspective exploded view of a third embodiment of the power plug adapter structure of the present invention;

FIG. 7 is a perspective exploded view of a fourth embodiment of the power plug adapter structure of the present invention;

FIG. 8 is a partially sectional assembled view of the fourth embodiment of the power plug adapter structure of the present invention; and

FIG. 9 is a partially sectional view according to FIG. 8, in which the plug adapter is to be separated from the power plug.

### DETAILED DESCRIPTION OF THE PREFERRED EMBODIMENTS

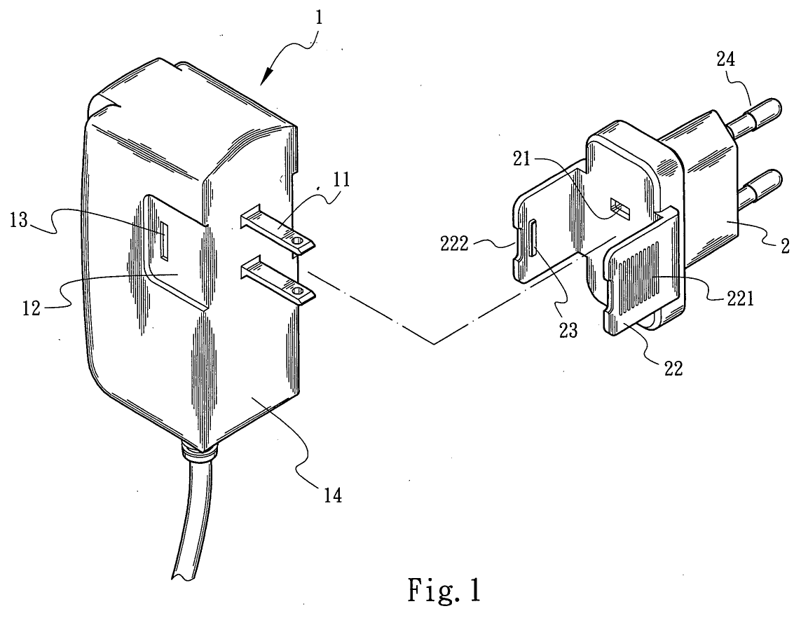

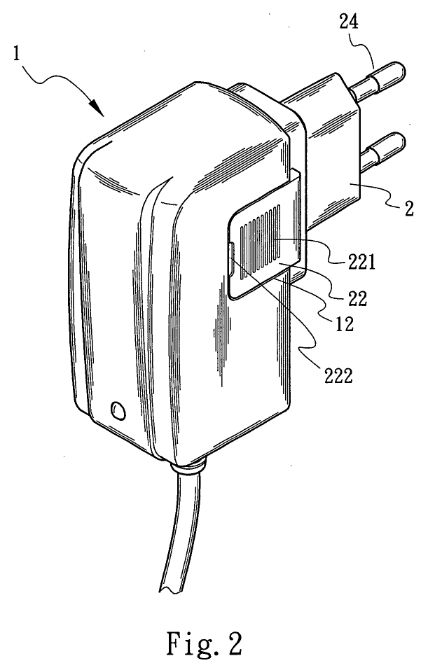

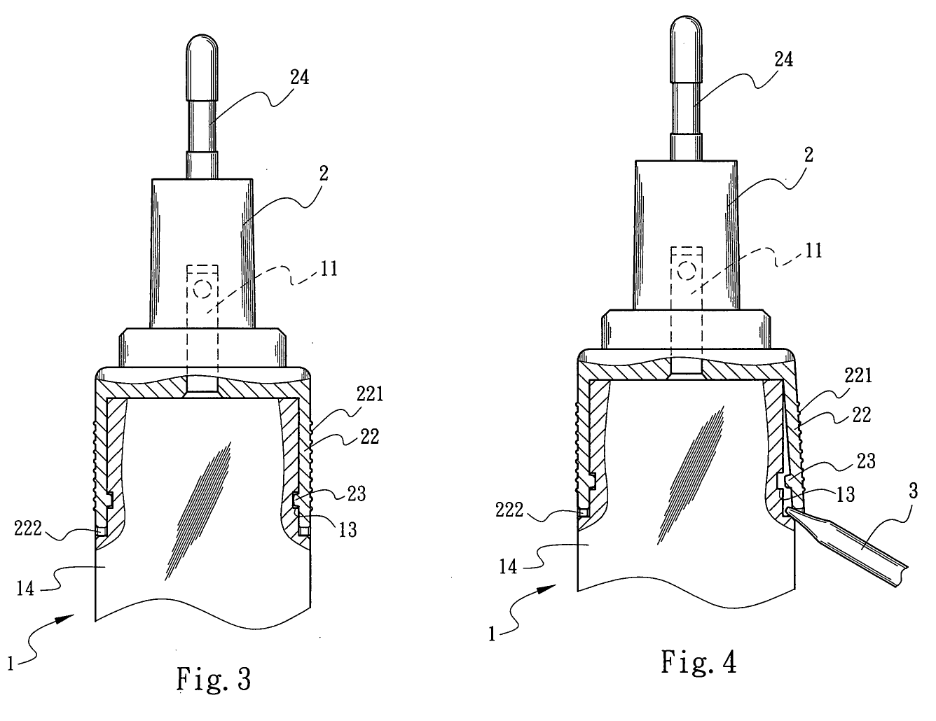

Please refer to FIGS. 1, 2 and 3. According to a first embodiment, the power plug adapter structure of the present invention includes a power plug 1 and a plug adapter 2. The power plug 1 has a mating face 14 and a set of first conductive members 11 disposed on the mating face 14. In this embodiment, the first conductive members 11 are elongated flat pins for electrically connecting with external power supply. The power plug 1 further has two lateral faces each having a lateral recess 12. The lateral recess 12 has an open side on the mating face 14. A first locating section 13 is formed on a bottom wall of the lateral recess 12. In this embodiment, the first locating section 13 is a dent. The plug adapter 2 has a set of second conductive members 24 protruding from one face of the adapter 2. In this embodiment, the second conductive members 24 are cylindrical pins different from the first conductive members 11 in specification and type. A set of insertion slots 21 are formed on another face of the plug adapter 2 opposite to the face with the second conductive members 24. The insertion slots 21 extend to the second conductive members 24 and are aligned with and compatible with the first conductive members 11. The plug adapter 2 further has two lateral extension sections 22 disposed on two sides of the plug adapter 2 in parallel to the insertion slots 21. The lateral extension sections 22 extend in a direction reverse to that of the insertion slots 21. The extension sections 22 are adapted to the lateral recesses 12 in size and shape. Each extension section 22 has a second locating section 23 corresponding to the first locating section 13 of the power plug 1. In this embodiment, the second locating section 23 is a rib. An edge of the extension section 22 is formed with at least one notch 222. In addition, an outer face of the extension section 22 is formed with multiple recessed/projecting friction stripes 221.

When it is necessary to transform the specification of the power plug 1, for example, from the type of the first conductive members 11 into the type of the second conductive members 24, the first conductive members 11 of the power plug 1 are directly inserted into the insertion slots 21 of the plug adapter 2 to electrically connect with the second conductive members 24. At the same time, the lateral extension sections 22 extend into the lateral recesses 12 and the second locating sections (ribs) 23 are inlaid in the first locating sections (dents) 13. The edges of the lateral extension sections 22 tightly abut against the sidewalls of the lateral recesses 12, whereby the plug adapter 2 is firmly combined with the power plug 1. After combined, top faces of the lateral extension sections 22 are flush with the lateral faces of the power plug 1 to keep the appearance tidy.

In the above arrangement, the second locating sections 23 can be forcedly detached from the first locating sections 13. The configurations of the first and second locating sections 23 are not limited to the configurations of the dents and ribs as shown in the drawings.

FIG. 4 shows how to disconnect the plug adapter from the power plug according to the first embodiment of the present invention. When the plug adapter 2 is combined with the power plug 1, the notch 222 of the lateral extension section 22 defines a larger gap between an edge of the lateral recess 12 and the notch 222. An external sharp piece such as a tool or fingernail can be extended into the notch 222 of the lateral extension section 22 to pry up the lateral extension section 22. At this time, the second locating section 23 (rib) is detached from the first locating section 13 (dent). Then, by means of the high friction of the friction stripes 221, a user can push the lateral extension section 22 backward to move out of the lateral recess 12. At the same time, the first conductive members 11 are extracted out of the insertion slots 21 to totally separate the plug adapter 2 from the power plug 1.

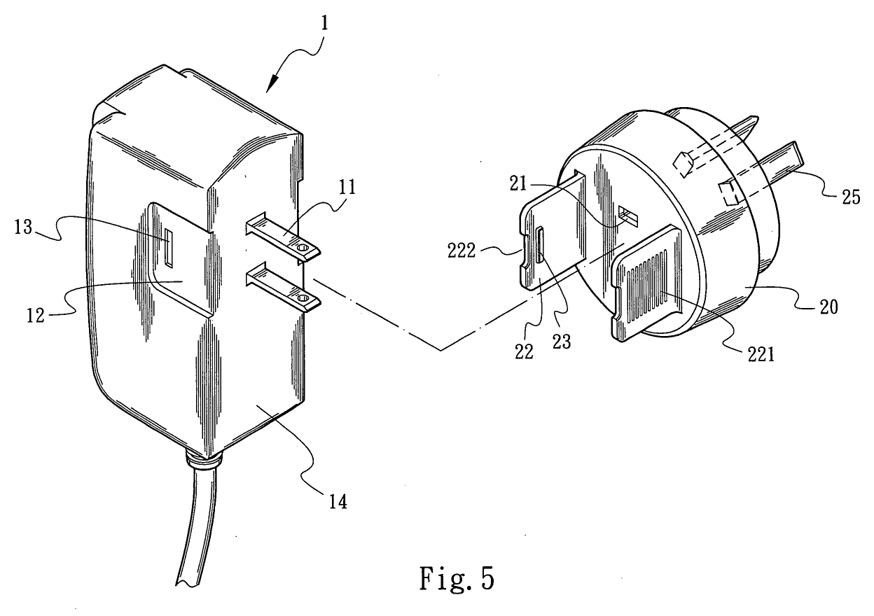

FIG. 5 shows a second embodiment of the present invention, in which the plug adapter 20 has different type of second conductive members 25. The second conductive members 25 are two oblique elongated flat pins. The power plug 1 and the other parts of the plug adapter 20 are identical to those of the first embodiment and thus will not be repeatedly described hereinafter.

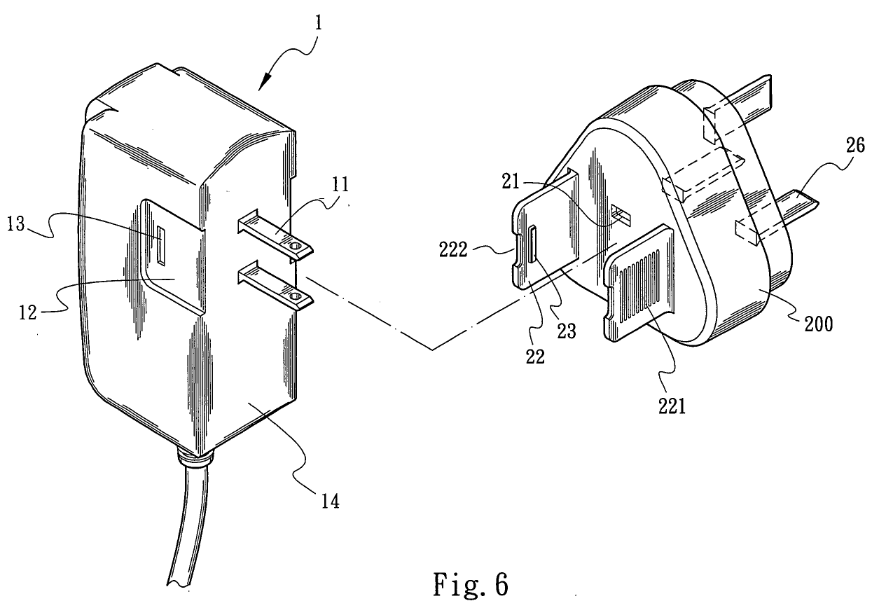

FIG. 6 shows a third embodiment of the present invention, in which the plug adapter 200 has different type of second conductive members 26. The second conductive members 26 are three oblique elongated flat pins as a biphase three-linear plug. The power plug 1 and the other parts of the plug adapter 200 are identical to those of the first embodiment. Accordingly, by means of the plug adapter, the power plug is adapted to various power sockets so that the application range of the power plug is widened.

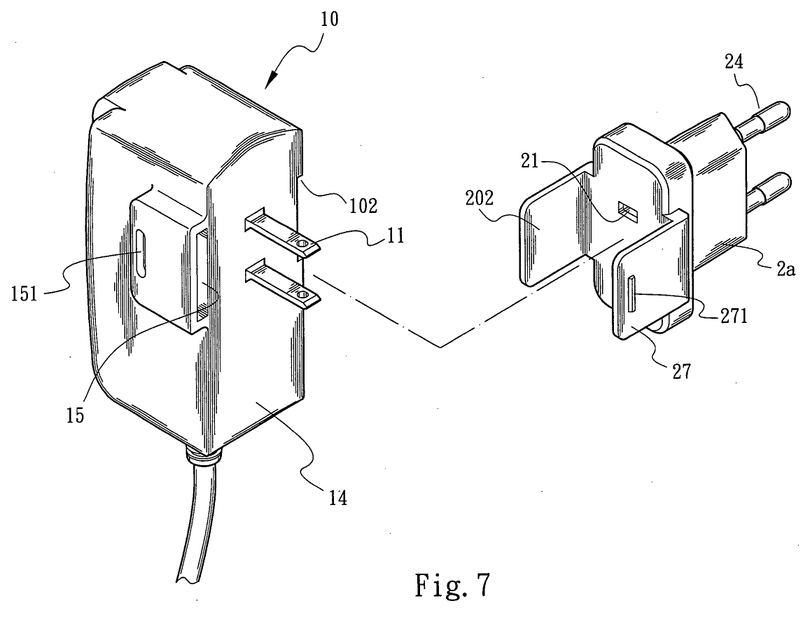

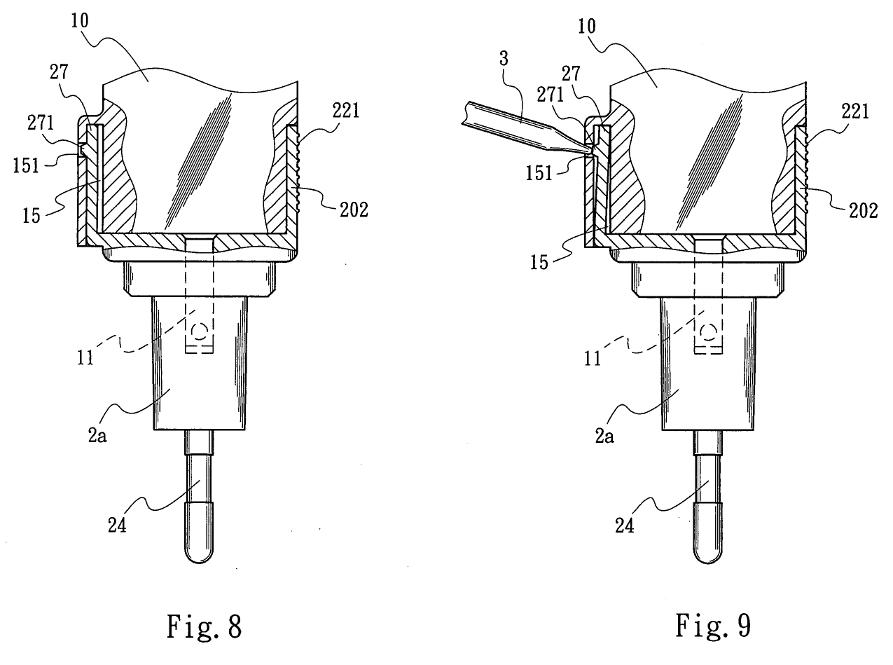

FIGS. 7 and 8 show a fourth embodiment of the present invention, which is configured on the basis of the structure of the first embodiment. At least one of the lateral extension sections 27 of the plug adapter 2a has a second locating section 271 formed on outer face of the lateral extension section 27. In this embodiment, the second locating section 271 is a rib. An outer face of the other lateral extension section 202 is simply formed with multiple friction stripes 221. A pocket 15 is formed on one side of the power plug 10 corresponding to the lateral extension section 27. A first locating section 151 is formed on a wall of the pocket 15. In this embodiment, the first locating section 151 is a slot. A lateral recess 102 is formed on the other side of the power plug 10 corresponding to the lateral extension section 202. When assembled, the first conductive members 11 of the power plug 10 are inserted into the insertion slots 21 of the plug adapter 2a. At the same time, the lateral extension section 27 of the plug adapter 2a reversely extends into the pocket 15 of the power plug 10 with the second locating section 271 inlaid in the first locating section 151. Also, the other lateral extension section 202 extends into the lateral recess 102, whereby the plug adapter 2a is fitted with the power plug 10.

FIG. 9 shows how to disconnect the plug adapter from the power plug according to the fourth embodiment of the present invention. An external piece 3 such as a tool or fingernail can be extended into the second locating section (the slot) 151 of the pocket 15 to push and bias the second locating section (the rib) 271. At this time, the second locating section (the rib) 271 moves out of the first locating section (the slot) 151, permitting a user to extract the lateral extension section 27 out of the pocket 15. At the same time, the other lateral extension section 202 is moved out of the lateral recess 102 to separate the plug adapter 2a from the power plug 10.

The fourth embodiment can be modified in such a manner that two identical lateral extension sections 27 are formed on two sides of the plug adapter 2a, while two identical pockets 15 are formed on two sides of the power plug 10 respectively corresponding to the lateral extension sections 27. Accordingly, the lateral extension sections 27 can be respectively inserted into the two pockets 15 and chucked therein to more firmly connect the plug adapter with the power plug.

The above embodiments are only used to illustrate the present invention, not intended to limit the scope thereof. Many modifications of the above embodiments can be made without departing from the spirit of the present invention.

1. A power plug adapter structure comprising:
a power plug having a mating face and at least one set of first conductive members disposed on the mating face for electrically connecting with external power supply, the power plug further having at least one lateral face on which a pocket is formed, the pocket having a first locating section formed on one side of the power plug; and
a plug adapter having a set of second conductive members protruding from one face of the plug adapter and a set of insertion slots formed on another face of the plug adapter, the insertion slots extending to the second conductive members and being aligned with and compatible with the first conductive members of the power plug, whereby the first conductive members can be inserted into the insertion slots to electrically connect with the second conductive members, the plug adapter further having at least one lateral extension section disposed on one side of the plug adapter in parallel to the insertion slots, the lateral extension section extending in a direction reverse to that of the insertion slots, a second locating section being formed on the lateral extension section corresponding to the first locating section of the power plug, whereby the second locating section can be chucked with the first locating section and the lateral extension section can be inserted into the pocket. when the plug adapter is combined with the power plug.

2. The power plug adapter structure as claimed in claim 1, wherein at least one lateral recess is formed on the lateral face of the power plug, the first locating section being formed on a wall of the lateral recess, the lateral recess having an open side on the mating face of the power plug, whereby the lateral extension section of the plug adapter can extend into the lateral recess.

3. The power plug adapter structure as claimed in claim 2, wherein the lateral extension section is adapted to the lateral recess in size and shape, whereby the lateral extension section can be sealingly snugly received in the lateral recess.

4. The power plug adapter structure as claimed in claim 1, wherein the second locating section and the first locating section are rib and dent in which the rib can be inlaid.

5. The power plug adapter structure as claimed in claim 2, wherein the second locating section and the first locating section are rib and dent in which the rib can be inlaid.

6. The power plug adapter structure as claimed in claim 1, wherein an outer face of the lateral extension section is formed with multiple recessed/projecting friction stripes.

7. The power plug adapter structure as claimed in claim 3, wherein an outer face of the lateral extension section is formed with multiple recessed/projecting friction stripes.

8. The power plug adapter structure as claimed in claim 1, wherein at least one edge of the extension section is formed with a notch, whereby when the plug adapter is combined with the power plug, the notch defines a larger gap between an edge of the lateral recess and the notch.

9. The power plug adapter structure as claimed in claim 2, wherein at least one edge of the extension section is formed with a notch, whereby when the plug adapter is combined with the power plug, the notch defines a larger gap between an edge of the lateral recess and the notch.

10. The power plug adapter structure as claimed in claim 4, wherein at least one edge of the extension section is formed with a notch, whereby when the plug adapter is combined with the power plug, the notch defines a larger gap between an edge of the lateral recess and the notch.

11. The power plug adapter structure as claimed in claim 6, wherein at least one edge of the extension section is formed with a notch, whereby when the plug adapter is combined with the power plug, the notch defines a larger gap between an edge of the lateral recess and the notch.

12. The power plug adapter structure as claimed in claim 1, wherein the second conductive members are different from the first conductive members in specification and type.

13. The power plug adapter structure as claimed in claim 2, wherein the second conductive members are different from the first conductive members in specification and type.

14. The power plug adapter structure as claimed in claim 3, wherein the second conductive members are different from the first conductive members in specification and type.

15. The power plug adapter structure as claimed in claim 4, wherein the second conductive members are different from the first conductive members in specification and type.

16. The power plug adapter structure as claimed in claim 6, wherein the second conductive members are different from the first conductive members in specification and type.

17. The power plug adapter structure as claimed in claim 8, wherein the second conductive members are different from the first conductive members in specification and type.

18. The power plug adapter structure as claimed in claim 1, wherein a pocket is formed on one side of the power plug corresponding to the lateral extension section of the plug adapter, whereby the lateral extension section can be inserted into the pocket.

19. The power plug adapter structure as claimed in claim 1, wherein the first locating section is formed on a wall of the pocket and the second locating section is formed on the lateral extension section corresponding to the first locating section, whereby when the lateral extension section is inserted into the pocket, the second locating section is chucked with the first locating section.

20. The power plug adapter structure as claimed in claim 19, wherein the second locating section and the first locating section are rib and slot in which the rib can be inlaid.

21. The power plug adapter structure as claimed in claim 19, wherein the second locating section and the first locating section are rib and slot in which the rib can be inlaid.

22. The power plug adapter structure as claimed in claim 1, wherein the second conductive members are different from the first conductive members in specification and type.

23. The power plug adapter structure as claimed in claim 19, wherein the second conductive members are different from the first conductive members in specification and type.

24. The power plug adapter structure as claimed in claim 20, wherein the second conductive members are different from the first conductive members in specification and type.

25. The power plug adapter structure as claimed in claim 21, wherein the second conductive members are different from the first conductive members in specification and type.
